(19) United States
(12) Patent Application Publication
(10) Pub. No.: US 2008/0008956 A1
(43) Pub. Date: Jan. 10, 2008

(54) Positive-working imageable members with branched hydroxystyrene polymers

(75) Inventors: Moshe Levanon, Ness-Ziona (IL); Joanne Ray, Fort Collins, CO (US); Kevin B. Ray, Fort Collins, CO (US); Larisa Postel, Ashdod (IL); Lee J. Korionoff, Fort Collins, CO (US)

Correspondence Address: Paul A. Leipold;Eastman Kodak Company, Patent Legal Staff, 343 State Street, Rochester, NY, 14650-2201, US

(73) Assignee: Eastman Kodak Company

(21) Appl. No.: 11/474,020

(22) Filed: Jun. 23, 2006

(51) Int. Cl. G03C 1/00

(52) U.S. Cl. 430/270.1

(57) ABSTRACT

Both single-layer and multi-layer positive-working imageable compositions can be used in positive-working elements having a substrate and at least one imageable layer. These elements can be used to prepare lithographic printing plates. The imageable elements include a radiation absorbing compound and a hydroxystyrene polymer having repeating branched hydroxystyrene units.

### FIELD OF THE INVENTION

This invention relates to both single- and multi-layer positive-working imageable elements having imageable layers containing branched hydroxystyrene polymers. This invention also relates to methods of imaging to provide positive-working imaged elements especially for lithographic printing.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. For example, the ink can be first transferred to an intermediate blanket that in turn is used to transfer the ink to the surface of the material upon which the image is to be reproduced.

Recent developments in the field of printing plate precursors concern the use of lasers or laser diodes for imaging. Laser exposure does not require conventional silver halide graphic arts films as intermediate information carriers (or “masks”) since the lasers can be controlled directly by computers. High-performance lasers or laser-diodes that are used in commercially-available image-setters generally emit radiation having a wavelength of at least 700 nm, and thus the radiation-sensitive compositions are required to be sensitive in the near-infrared or infrared region of the electromagnetic spectrum. However, other useful radiation-sensitive compositions are designed for imaging with ultraviolet or visible radiation.

Imageable elements useful to prepare lithographic printing plates typically comprise an imageable layer applied over the hydrophilic surface of a substrate. The imageable layer includes one or more radiation-sensitive components that can be dispersed in a suitable binder. Alternatively, the radiation-sensitive component can also be the binder material. Following imaging, either the imaged regions or the non-imaged regions of the imageable layer are removed by a suitable developer, revealing the underlying hydrophilic surface of the substrate. If the imaged regions are removed, the element is considered as positive-working. If the non-imaged regions are removed, the element is considered as negative-working. In each instance, the regions of the imageable layer (that is, the image areas) that remain are ink-receptive, and the regions of the hydrophilic surface revealed by the developing process accept water and aqueous solutions (typically a fountain solution) and repel ink.

Imaging of the imageable element with ultraviolet and/or visible radiation is typically carried out through a mask that has clear and opaque regions. Imaging takes place in the regions under the clear regions of the mask but does not occur in the regions under the opaque mask regions. Use of a mask is time-consuming and has a number of significant disadvantages.

Direct digital imaging has obviated the need for imaging through a mask and is becoming increasingly important in the printing industry. Imageable elements for the preparation of lithographic printing plates have been developed for use with infrared lasers. Thermally imageable, multi-layer elements are described, for example, U.S. Pat. No. 6,294,311 (Shimazu et al.), U.S. Pat. No. 6,352,812 (Shimazu et al.), U.S. Pat. No. 6,593,055 (Shimazu et al.), U.S. Pat. No. 6,352,811 (Patel et al.), U.S. Pat. No. 6,358,669 (Savariar-Hauck et al.), and U.S. Pat. No. 6,528,228 (Savariar-Hauck et al.), U.S. Patent Application Publication 2004/0067432 A1 (Kitson et al.).

Photoresists containing a polyhydroxystyrene (PHS) that is prepared from 4-hydroxystyrene (HSM) are described for example in U.S. Pat. No. 5,554,719 (Sounik) and U.S. Pat. No. 6,551,758 (Ohsawa et al.). Branched polyhydroxystyrenes are also known for use in photoresists as described in U.S. Pat. No. 6,682,869 (Ohsawa et al.). They have also been described for use in color-forming materials containing leuco dyes in U.S. Patent Application Publication 2003/0050191 (Bhatt et al.) and in data storage media as described in U.S. Patent Application Publication 2005/0051053 (Wisnudel et al.).

### Problem to be Solved

Positive-working lithographic printing plates should have high imaging speed, image resolution, and good aqueous developer solubility. It is also desired that the developers used in processing can be used at lower pH and require minimal filtration. While the extensive lithographic printing literature describes various positive-working imageable elements with various polymeric binders to provide useful properties, there is a continuing need to improve such elements and especially to provide improved processability.

### SUMMARY OF THE INVENTION

The present invention provides a non-color forming, positive-working radiation-sensitive composition that upon exposure to radiation, becomes soluble or dispersible in an alkaline solution, the composition comprising a radiation-absorbing compound and a branched hydroxystyrene polymer.

This invention also provides a positive-working imageable element comprising a substrate having thereon an imageable layer that upon exposure to radiation, becomes soluble or dispersible in an alkaline solution and comprises a branched hydroxystyrene polymer, the element further comprising a radiation absorbing compound.

In some embodiments, the positive-working imageable elements comprise a single imageable layer disposed on the substrate that comprises both the branched hydroxystyrene polymer and the radiation absorbing compound.

In other embodiments, the positive-working imageable elements comprise, on the substrate, in order:

an inner layer, and

an ink receptive outer layer that is not removable using alkaline developer before its exposure to imaging radiation, the outer layer comprising the branched hydroxystyrene polymer, wherein the radiation absorbing compound is usually predominantly present in the inner layer.

This invention also provides a method for forming an image comprising:

A) thermally imaging the positive-working imageable element of this invention, thereby forming an imaged element with exposed and non-exposed regions,

B) contacting the imaged layer with an alkaline developer to remove only the exposed regions, and

C) optionally, baking the imaged and developed element.

Further, this invention provides a method of providing a positive working imageable element comprising:

A) providing an imageable layer on a substrate to provide a positive-working imageable element, the imageable layer comprising a branched hydroxystyrene polymer,

B) providing a radiation absorbing compound within the element, and

C) after drying the imageable layer, heat treating the imageable layer at from about 40 to about 90° C. for at least 4 hours under conditions that inhibit the removal of moisture from the dried imageable layer.

This invention thus also provides imaged elements from the positive-working elements described herein.

The positive-working imageable compositions and elements of this invention have improved imaging speed (sensitivity) and are clean processing with good aqueous developer solubility and minimal developer filtration required. The imageable materials can be readily processed using either dip-tank or spray-bar processing. They can be single-layer or multi-layer elements and thus useful for a variety of applications in the lithographic printing industry.

These advantages are achieved by using a branched hydroxystyrene polymer as a polymeric binder in the imageable layer of the imageable elements. The imageable layer formulations containing the branched hydroxystyrene polymer also have a viscosity that allows for improved coatability.

### DETAILED DESCRIPTION OF THE INVENTION

### Definitions

Unless the context indicates otherwise, when used herein, the terms “radiation-sensitive”, “imageable element” and “printing plate precursor” are meant to be references to embodiments of the present invention.

By “single-layer” imageable element, we mean an imageable element of this invention that has only a single layer needed for providing a positive image. The “branched hydroxystyrene polymer” (defined below) would be located in this single imaging layer that may be the outermost layer. However, such elements may comprise additional non-imaging layers [such as subbing layers or an overcoat comprising an oxygen-impermeable, water-soluble polymer such as a poly(vinyl alcohol)] on either side of the substrate.

By “multilayer” imageable element, we mean an imageable element of this invention that has at least two layers required for providing an image, for example, “inner” and “outer” layers as described below. The “branched hydroxystryene polymer” (defined below) would usually be located in the outer layer. However, such elements may comprise additional non-imaging layers on either side of the substrate, including but not limited to overcoat, subbing, and adhesion layers.

The term “branched hydroxystyrene polymer” (BHP) refers to polymers, both homopolymers and copolymers, that comprise recurring units derived from a hydroxystyrene (preferably 4-hydroxystyrene or p-hydroxystyrene) wherein at least some of those recurring units are further substituted with repeating hydroxystyrene units that are positioned ortho to the hydroxy group. These polymers are described in more detail below.

In addition, unless the context indicates otherwise, the various components described herein such as “branched hydroxystyrene polymer”, and “radiation absorbing compound”, and other components and terms used in the imageable compositions, elements, and methods of this invention also refer to mixtures of such components. Thus, the use of the article “a”, “an”, or “the” is not necessarily meant to refer to only a single component.

“Polydispersity” refers to the ratio of weight average molecular weight (M_{w}) to number average molecular weight (Mₙ) and when the ratio is 1.0, it refers to a perfectly monodisperse polymer.

Unless otherwise indicated, percentages refer to percents by dry weight.

The term “radiation absorbing compound” refers to compounds that are sensitive to certain wavelengths of radiation and can convert photons into heat within the layer in which they are disposed. These compounds may also be known in the art as “photothermal conversion materials”, “sensitizers”, or “light to heat converters”.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any definitions explicitly set forth herein should be regarded as controlling.

Unless otherwise indicated, the term “polymer” refers to high and low molecular weight polymers including oligomers and includes homopolymers and copolymers.

“Homopolymer” refers to a polymer that is composed of essentially of (>99 mol %) the same recurring unit.

The term “copolymer” refers to polymers that are derived from two or more different monomers or they comprise recurring units having at least two different chemical structures.

The term “backbone” refers to the chain of atoms in a polymer to which a plurality of pendant groups can be attached. An example of such a backbone is an “all carbon” backbone obtained from the polymerization of one or more ethylenically unsaturated polymerizable monomers. However, other backbones can include heteroatoms wherein the polymer is formed by a condensation reaction or some other means.

### Uses

The radiation-sensitive compositions and imageable elements can be used to provide imaged elements for various purposes. The preferred use is as positive-working lithographic printing plate precursors as described in more detail below. However, this is not meant to be the only use of the present invention. For example, the imageable elements can also be used as thermal patterning systems and to form masking elements and printed circuit boards. The radiation-sensitive compositions and imageable elements are not intended to be color-forming in the manner of the materials described in U.S. Patent Application Publication 2003/0050191 (noted above).

### Branched hydroxystyrene polymers

The branched hydroxystyrene polymers that provide the advantages in the compositions and imageable elements comprise recurring units derived from a hydroxystyrene, such as from 4-hydroxystyrene, which recurring units are further substituted with repeating hydroxystyrene units (such as 4-hydroxystyrene units) positioned ortho to the hydroxy group. For the sake of simplicity, the rest of the discussion will refer to “4-hydroxystyrene” but this is not intended to limit the invention by excluding other hydroxystyrene monomers such as 2-hydroxystyrene and 3-hydroxystyrene.

These branched polymers have a weight average molecular weight (M_{w}) of from about 1,000 to about 30,000, preferably from about 1,000 to about 10,000, and more preferably from about 3,000 to about 7,000. In addition, they have a polydispersity less than 2 and preferably from about 1.5 to about 1.9.

In some embodiments, the branched hydroxystyrene polymer is a homopolymer wherein essentially every hydroxystyrene recurring unit is further substituted (thus, “branched”) with repeating 4-hydroxystyrene units positioned ortho to the hydroxyl groups. Such branched 4-hydroxystyrene homopolymers contain essentially only “branched hydroxystyrene recurring units” that are illustrated, for example, in the following Structure (I) wherein the broken bonds can be completed with hydrogen or additional repeating 4-hydroxystyrene units:

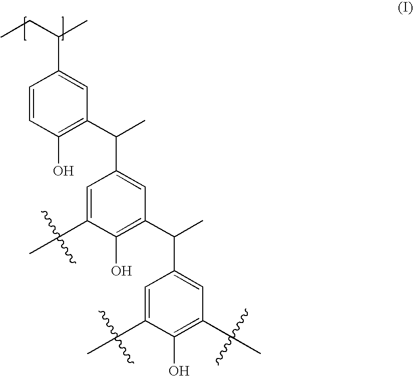

The branched hydroxystyrene polymer can be a homopolymer or copolymer in which most of the recurring units (at least 90 mol % and preferably at least 95 mol %) are branched hydroxystyrene recurring units as defined above with Structure (I). Thus, such homopolymers and copolymers can be represented by the following Structure (II):

-(A)ₓ-(B)_{y}- (II)

wherein A and B together provide a polymer backbone in which A represents branched hydroxystyrene recurring units as defined in Structure (I), B represents non-branched hydroxystyrene recurring units, x represents from about 90 to 100 mol %, and y represents 0 to about 10 mol %. Preferably, x is from about 95 to 100 mol % and y is from 0 to about 5 mol %.

Other copolymers useful in this invention have at least 60 mol % of the recurring units derived from hydroxystyrene wherein at least 90 mol % of said branched hydroxystyrene recurring units are further substituted with repeating hydroxystyrene units positioned ortho to the hydroxy groups. For example, more particularly, hydroxystyrene copolymers can be represented by the following Structure (III):

-(A)ₓ-(B)_{y}-(C)_{z}- (III)

wherein A, B, and C together provide a polymer backbone in which A represents branched hydroxystyrene recurring units as defined in Structure (I) above, B represents non-branched hydroxystyrene recurring units, and C represents recurring units different from the A and B recurring units, x represents from about 60 to about 95 mol %, y represents 0 to about 10 mol %, z represents from 0 to about 40 mol %. Preferably, x is from about 75 to about 90 mol %, y is from 0 to about 5 mol %, and z is from 0 to about 20 mol %.

The monomers from which the C recurring units are derived from include but are not limited to, one or more of a (meth)acrylate, (meth)acrylamide, vinyl ether, vinyl ester, vinyl ketone, olefin, unsaturated imide, unsaturated anhydride, N-vinyl pyrrolidone, N-vinyl carbazole, 4-vinyl pyridine, (meth)acrylonitrile, and styrenic monomer other than a hydroxystyrene monomer. Preferably, these recurring units are derived from one or more of a (meth)acrylate, (meth)acrylonitrile, N-substituted maleimide, and (meth)acrylamide.

The branched hydroxystyrene polymers can be prepared by any of the methods described in the art, including for example, the methods described in U.S. Pat. No. 5,554,719 (Sounik) and U.S. Pat. No. 6,455,223 (Hatakayama et al.) and U.S. Patent Application Publication 2006/0099531 (Sheehan et al.), all incorporated herein by reference. A number of such branched hydroxystyrene polymers are also available commercially as noted in the Examples below.

Generally, the branched hydroxystyrene polymer is present at a solids content (composition) or dry coverage (element) of from about 10 to about 99 weight % depending upon the type of element in which is it used. In the radiation-sensitive composition, the polymer is combined with the radiation absorbing compound that is preferably an infrared radiation absorbing compound.

For the single-layer imageable elements, the branched hydroxystyrene polymer is generally present at a coverage of from about 80 to about 99.5 weight %, and preferably from about 90 to about 99.5 weight %, based on dry layer weight, and comprises from about 10 to about 100 weight of the total polymeric binders in the single imageable layer.

In the multi-layer imageable elements, the branched hydroxystyrene polymer is generally present (preferably in the outermost imageable layer) at a coverage of from about 20 to about 99.5 weight % and comprises from about 10 to 100 weight % of the total polymeric binders based on the dry weight of that layer.

### Single-Layer Imageable Elements

The single-layer imageable elements are positive-working imageable elements and the branched hydroxystyrene polymers described herein are generally present as polymeric binders in the single imageable layer of these elements. Preferably, they are the only polymeric binders in the imageable layer.

In general, the single-layer imageable elements are formed by suitable application of a formulation of the radiation-sensitive composition that contains one or more branched hydroxystyrene polymers and a radiation absorbing compound to a suitable substrate to form an imageable layer. This substrate is usually treated or coated in various ways as described below prior to application of the formulation. The substrate can be treated to provide an “interlayer” for improved adhesion or hydrophilicity, and the single imageable layer is applied over the interlayer.

The substrate generally has a hydrophilic surface, or at least a surface that is more hydrophilic than the applied imaging formulation on the imaging side. The substrate comprises a support that can be composed of any material that is conventionally used to prepare imageable elements such as lithographic printing plates. It is usually in the form of a sheet, film, or foil, and is strong, stable, and flexible and resistant to dimensional change under conditions of use so that color records will register a full-color image. Typically, the support can be any self-supporting material including polymeric films (such as polyester, polyethylene, polycarbonate, cellulose ester polymer, and polystyrene films), glass, ceramics, metal sheets or foils, or stiff papers (including resin-coated and metallized papers), or a lamination of any of these materials (such as a lamination of an aluminum foil onto a polyester film). Metal supports include sheets or foils of aluminum, copper, zinc, titanium, and alloys thereof.

Polymeric film supports may be modified on one or both surfaces with a “subbing” layer to enhance hydrophilicity, or paper supports may be similarly coated to enhance planarity. Examples of subbing layer materials include but are not limited to, alkoxysilanes, amino-propyltriethoxysilanes, glycidioxypropyl-triethoxysilanes, and epoxy functional polymers, as well as conventional hydrophilic subbing materials used in silver halide photographic films (such as gelatin and other naturally occurring and synthetic hydrophilic colloids and vinyl polymers including vinylidene chloride copolymers).

A preferred substrate is composed of an aluminum support that may be coated or treated using techniques known in the art, including physical graining, electrochemical graining and chemical graining, followed by anodizing. Preferably, the aluminum sheet is mechanically or electrochemically grained and anodized using phosphoric acid or sulfuric acid and conventional procedures.

An optional interlayer may be formed by treatment of the aluminum support with, for example, a silicate, dextrine, calcium zirconium fluoride, hexafluorosilicic acid, phosphate/sodium fluoride, poly(vinyl phosphonic acid) (PVPA), vinyl phosphonic acid copolymer, poly(acrylic acid), or acrylic acid copolymer solution. Preferably, the grained and anodized aluminum support is treated with poly(acrylic acid) using known procedures to improve surface hydrophilicity.

The thickness of the substrate can be varied but should be sufficient to sustain the wear from printing and thin enough to wrap around a printing form. Preferred embodiments include a treated aluminum foil having a thickness of from about 100 to about 600 μm.

The backside (non-imaging side) of the substrate may be coated with antistatic agents and/or slipping layers or a matte layer to improve handling and “feel” of the imageable element.

The substrate can also be a cylindrical surface having the radiation-sensitive composition applied thereon, and thus be an integral part of the printing press. The use of such imaged cylinders is described for example in U.S. Pat. No. 5,713,287 (Gelbart).

Thus, the imageable layer comprises one or more of the branched hydroxystyrene polymers (described above) and one or more radiation absorbing compounds. While these compounds can be sensitive to any suitable energy form (for example, UV and visible radiation) from about 150 to about 1500 nm, they are preferably sensitive to infrared radiation and thus, the radiation absorbing compounds are known as infrared radiation absorbing compounds (“IR absorbing compounds”) that absorbs radiation from about 600 to about 1400 nm and preferably from about 700 to about 1200 nm. The imageable layer is generally the outermost layer in the single-layer imageable element.

Examples of suitable IR dyes include but are not limited to, azo dyes, squarylium dyes, croconate dyes, triarylamine dyes, thioazolium dyes, indolium dyes, oxonol dyes, oxazolium dyes, cyanine dyes, merocyanine dyes, phthalocyanine dyes, indocyanine dyes, indotricarbocyanine dyes, hemicyanine dyes, streptocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo)-polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, polymethine dyes, squarine dyes, oxazole dyes, croconine dyes, porphyrin dyes, and any substituted or ionic form of the preceding dye classes. Suitable dyes are described for example, in U.S. Pat. No. 4,973,572 (DeBoer), U.S. Pat. No. 5,208,135 (Patel et al.), U.S. Pat. No. 5,244,771 (Jandrue Sr. et al.), and U.S. Pat. No. 5,401,618 (Chapman et al.), and EP 0 823 327A1 (Nagasaka et al.), all of which are incorporated herein by reference.

Cyanine dyes having an anionic chromophore are also useful. For example, the cyanine dye may have a chromophore having two heterocyclic groups. In another embodiment, the cyanine dye may have at least two sulfonic acid groups, more particularly two sulfonic acid groups and two indolenine groups. Useful IR-sensitive cyanine dyes of this type are described for example in U.S Patent Application Publication 2005-0130059 (Tao) that is incorporated by reference.

A general description of a useful class of suitable cyanine dyes is shown by the formula in paragraph 0026 of WO 2004/101280 (Munnelly et al.), incorporated herein by reference.

In addition to low molecular weight IR-absorbing dyes, IR dye moieties bonded to polymers can be used as well. Moreover, IR dye cations can be used as well, that is, the cation is the IR absorbing portion of the dye salt that ionically interacts with a polymer comprising carboxy, sulfo, phospho, or phosphono groups in the side chains.

Near infrared absorbing cyanine dyes are also useful and are described for example in U.S. Pat. No. 6,309,792 (Hauck et al.), U.S. Pat. No. 6,264,920 (Achilefu et al.), U.S. Pat. No. 6,153,356 (Urano et al.), U.S. Pat. No. 5,496,903 (Watanate et al.). Suitable dyes may be formed using conventional methods and starting materials or obtained from various commercial sources including American Dye Source (Baie D'Urfe, Quebec, Canada) and FEW Chemicals (Germany). Other useful dyes for near infrared diode laser beams are described, for example, in U.S Pat. No. 4,973,572 (noted above).

Useful IR absorbing compounds include various pigments including carbon blacks such as carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful. Other useful pigments include, but are not limited to, Heliogen Green, Nigrosine Base, iron (III) oxides, manganese oxide, Prussian Blue, and Paris Blue. The size of the pigment particles should not be more than the thickness of the imageable layer and preferably the pigment particle size will be less than half the thickness of the imageable layer.

In the single-layer imageable elements, the radiation absorbing compound is generally present at a dry coverage of from about 0.5 to about 5 weight %, and preferably it is an IR dye that is present in an amount of from about 0.5 to about 3 weight %. Alternatively, the amount can be defined by an absorbance in the range of from about 0.05 to about 3, and preferably from about 0.1 to about 1.5, in the dry film as measured by reflectance UV-visible spectrophotometry. The particular amount needed for this purpose would be readily apparent to one skilled in the art, depending upon the specific compound used.

Alternatively, the radiation absorbing compounds may be included in a separate layer that is in thermal contact with the single imageable layer. Thus, during imaging, the action of the radiation absorbing compound can be transferred to the imageable layer without the compound originally being incorporated into it.

The imageable layer can also include one or more additional compounds that act as dissolution inhibitors that function as solubility-suppressing components for the branched hydroxystyrene polymers. Dissolution inhibitors typically have polar functional groups that are believed to act as acceptor sites for hydrogen bonding with various groups in the polymeric binders. The acceptor sites comprise atoms with high electron density, preferably selected from electronegative first row elements such as carbon, nitrogen, and oxygen. Dissolution inhibitors that are soluble in an alkaline developer are preferred. Useful polar groups for dissolution inhibitors include but are not limited to, ether groups, amine groups, azo groups, nitro groups, ferrocenium groups, sulfoxide groups, sulfone groups, diazo groups, diazonium groups, keto groups, sulfonic acid ester groups, phosphate ester groups, triarylmethane groups, onium groups (such as sulfonium, iodonium, and phosphonium groups), groups in which a nitrogen atom is incorporated into a heterocyclic ring, and groups that contain a positively charged atom (such as quaternized ammonium group). Compounds that contain a positively-charged nitrogen atom useful as dissolution inhibitors include, for example, tetralkyl ammonium compounds and quaternized heterocyclic compounds such as quinolinium compounds, benzothiazolium compounds, pyridinium compounds, and imidazolium compounds. Further details and representative compounds useful as dissolution inhibitors are described for example in U.S. Pat. No. 6,294,311 (noted above). Particularly useful dissolution inhibitors include triarylmethane dyes such as ethyl violet, crystal violet, malachite green, brilliant green, Victoria blue B, Victoria blue R, and Victoria pure blue BO, BASONYL® Violet 610 and D11 (PCAS, Longjumeau, France). These compounds can also act as contrast dyes that distinguish the unimaged areas from the imaged areas in the developed imageable element.

When a dissolution inhibitor is present in the imageable layer, its amount can vary widely, but generally it is present in an amount of at least 0.5 weight % and up to 30 weight %, and preferably from about 1 to about 15 weight % (based on the total dry layer weight).

The imageable layer may also include one or more additional binder resins, with or without polar groups, or a mixture of binder resins, some with polar groups and others without polar groups. The most suitable additional binder resins include phenolic resins such as novolak and resole resins, and such resins can also include one or more pendant diazo, carboxylate ester, phosphate ester, sulfonate ester, sulfinate ester, or ether groups. The hydroxy groups of the phenolic resins can be converted to -T-Z groups in which T represents a polar group and Z represents a non-diazide functional group as described for example in U.S. Pat. No. 6,218,083 (McCullough et al.) and WO 99/001795 (McCullough et al.). The hydroxy groups can also be derivatized with diazo groups containing o-naphthoquinone diazide moieties as described for example in U.S. Pat. No. 5,705,308 (West et al.) and U.S. Pat. No. 5,705,322 (West et al.). These additional binder resins can be present in the imageable layer in an amount of from 0 to about 50 weight %) and preferably at from 0 to about 25 weight % (based on total layer dry weight).

The imageable layer can further include a variety of additives including dispersing agents, humectants, biocides, plasticizers, surfactants for coatability or other properties, viscosity builders, dyes or colorants to allow visualization of the written image, pH adjusters, drying agents, defoamers, preservatives, antioxidants, development aids, rheology modifiers or combinations thereof, or any other addenda commonly used in the lithographic art, in conventional amounts.

The positive-working single-layer imageable element can be prepared by applying the layer formulation(s) over the surface of the substrate (and any other hydrophilic layers provided thereon) using conventional coating or lamination methods. Thus, the formulations can be applied by dispersing or dissolving the desired ingredients in a suitable coating solvent, and the resulting formulations are sequentially or simultaneously applied to the substrate using suitable equipment and procedures, such as spin coating, knife coating, gravure coating, die coating, slot coating, bar coating, wire rod coating, roller coating, or extrusion hopper coating. The formulations can also be applied by spraying onto a suitable support (such as an on-press printing cylinder).

The coating weight for the single imageable layer is from about 0.5 to about 2.5 g/m² and preferably from about 1 to about 2 g/m².

The selection of solvents used to coat the layer formulation(s) depends upon the nature of the branched hydroxystyrene polymers and other polymeric materials and non-polymeric components in the formulations. Generally, the imageable layer formulation is coated out of acetone or another ketone, tetrahydrofuran, 1 -methoxy propan-2-ol, 1-methoxy-2-propyl acetate, and mixtures thereof using conditions and techniques well known in the art.

Alternatively, the layer(s) may be applied by conventional extrusion coating methods from melt mixtures of the respective layer compositions. Typically, such melt mixtures contain no volatile organic solvents.

Intermediate drying steps may be used between applications of the various layer formulations to remove solvent(s) before coating other formulations. Drying steps may also help in preventing the mixing of the various layers.

A representative method for preparing positive-working single-layer imageable elements is described below in Example 1.

### Multilayer Imageable Elements

In general, the multilayer imageable elements comprise a substrate, at least one inner layer (also known as an “underlayer”), and an outer layer (also known as a “top layer” or “topcoat”) disposed over the inner layer. Before thermal imaging, the outer layer is not removable by an alkaline developer, but after thermal imaging, the imaged regions of the outer layer are removable by the alkaline developer. The inner layer(s) are also removable by the alkaline developer. One or more branched hydroxystyrene polymers (as described above) are essentially all present in the outer layer. That is, at least 99 weight % of the total branched hydroxystyrene polymer in the element is in the outer layer. A radiation absorbing compound (as defined above) is preferably predominantly present in the inner layer at a dry coverage of from about 5 to about 25 weight % and preferably from about 5 to about 15 weight %. Alternatively, this compound can be present in a separate layer between the inner and outer layers.

The multi-layer imageable elements are formed by suitable application of an inner layer composition to a suitable substrate that is described in detail above in relation to the single-layer imageable elements. Grained and anodized aluminum sheets are preferred substrates for the multi-layer imageable elements. Such sheets have also preferably been treated with PVPA (noted above).

The inner layer is disposed between the outer layer and the substrate. It is disposed over the substrate and, more typically, disposed directly on the substrate. The inner layer comprises one or more polymeric materials as binders. Preferred polymeric materials, when present, are novolak resins that may be added to improve the run length of the printing member when a post-development bake process is used. Other useful polymeric materials for the inner layer include polyvinyl acetals, (meth)acrylic resins comprising carboxy groups, vinyl acetate crotonate-vinyl neodecanoate copolymer phenolic resins, maleated wood rosins, styrene-maleic anhydride co-polymers, (meth)acrylamide polymers, polymers derived from an N-substituted cyclic imide, and combinations thereof. Polymeric materials that provide resistance both to fountain solution and aggressive washes are disclosed in U.S. Pat. No. 6,294,311 (noted above) that is incorporated herein by reference.

Particularly useful polymeric materials include polyvinyl acetals, and copolymers derived from an N-substituted cyclic imide (especially N-phenylmaleimide), a (meth)acrylamide (especially methacrylamide), and a (meth)acrylic acid (especially methacrylic acid). The preferred polymeric materials of this type are copolymers that comprise from about 20 to about 75 mol% and preferably about 35 to about 60 mol% or recurring units derived from N-phenylmaleimide, N-cyclohexylmaleimide, N-benzylmaleimide, or a mixture thereof, from about 10 to about 50 mol % and preferably from about 15 to about 40 mol % of recurring units derived from acrylamide, methacrylamide, or a mixture thereof, and from about 5 to about 30 mol % and preferably about 10 to about 30 mol % of recurring units derived from methacrylic acid. Other hydrophilic monomers, such as hydroxyethyl methacrylate, may be used in place of some or all of the methacrylamide. Other alkaline soluble monomers, such as acrylic acid, may be used in place of some or all of the methacrylic acid. Optionally, these polymers can also include recurring units derived from (meth)acrylonitrile or N-[2-(2-oxo-1-imidazolidinyl)ethyl]methacrylamide. These polymeric materials are soluble in a methyl lactate/methanol/dioxolane (15:42.5:42.5 wt. %) mixture that can be used as the coating solvent for the inner layer. However, they are poorly soluble in solvents such as acetone and toluene that can be used as solvents to coat the outer layer over the inner layer without dissolving the inner layer.

The inner layer may also comprise one or more secondary polymeric materials that are resins having activated methylol and/or activated alkylated methylol groups. Such resins include, for example resole resins and their alkylated analogs, methylol melamine resins and their alkylated analogs (for example melamine-formaldehyde resins), methylol glycoluril resins and alkylated analogs (for example, glycoluril-formaldehyde resins), thiourea-formaldehyde resins, guanamine-formaldehyde resins, and benzoguanamine-formaldehyde resins. Commercially available melamine-formaldehyde resins and glycoluril-formaldehyde resins include, for example, CYMEL® resins (Cytec Industries, Inc.) and NIKALAC® resins (Sanwa Chemical).

The resin having activated methylol and/or activated alkylated methylol groups is preferably a resole resin or a mixture of resole resins. Resole resins are well known to those skilled in the art. They are prepared by reaction of a phenol with an aldehyde under basic conditions using an excess of phenol. Commercially available resole resins include, for example, GP649D99 resole (Georgia Pacific).

Other useful secondary polymeric materials include copolymers that comprises from about 1 to about 30 mole % and preferably from about 3 to about 20 mole % of recurring units derived from N-phenylmaleimide, from about 1 to about 30 mole % and preferably from about 5 to about 20 mole % of recurring units derived from methacrylamide, from about 20 to about 75 mole % and preferably from about 35 to about 60 mole % of recurring units derived from acrylonitrile, and from about 20 to about 75 mole % and preferably from about 35 to about 60 mole % of recurring units derived from one or more monomers of the following Structure (IV):

CH₂═C(R₃)—CO₂—CH₂CH₂—NH—CO—NH-p-C₆H₄—R₂ (IV)

wherein R₂ is OH, COOH, or SO₂NH₂, and R₃ is H or methyl, and, optionally, from about 1 to about 30 mole % and preferably, when present, from about 3 to about 20 mole % of recurring units derived from one or more monomers of the following Structure (V):

CH₂═C(R₅)—CO—NH-p-C₆H₄—R₄ (V)

wherein R₄ is OH, COOH, or SO₂NH₂, and R₅ is H or methyl.

Other useful secondary polymeric materials can include copolymers that comprise from about 25 to about 75 mole % and about 35 to about 60 mole % of recurring units derived from N-phenylmaleimide, from about 10 to about 50 mole % and preferably from about 15 to about 40 mole % of recurring units derived from methacrylamide, and from about 5 to about 30 mole % and preferably from about 10 to about 30 mole % or recurring units derived from methacrylic acid. These secondary copolymers are disclosed in U.S. Pat. Nos. 6,294,311 and 6,528,228 (both noted above).

Any additional polymeric materials as described above can be present in an amount of from about 5 to about 45 weight % and preferably from about 5 to about 25 weight % based on the total dry weight of the inner layer.

The polymeric materials useful in the inner layer can be prepared by methods, such as free radical polymerization, that are well known to those skilled in the art and that are described, for example, in Chapters 20 and 21, of Macromolecules, Vol. 2, 2nd Ed., H. G. Elias, Plenum, N.Y., 1984. Useful free radical initiators are peroxides such as benzoyl peroxide, hydroperoxides such as cumyl hydroperoxide and azo compounds such as 2,2′-azobis(isobutyronitrile) (AIBN). Suitable reaction solvents include liquids that are inert to the reactants and that will not otherwise adversely affect the reaction.

The inner layer can include other components such as surfactants, dispersing aids, humectants, biocides, viscosity builders, drying agents, defoamers, preservatives, antioxidants, and colorants.

The inner layer generally has a dry coating coverage of from about 0.5 to about 2.5 g/m² and preferably from about 1 to about 2 g/m².

The outer layer of the imageable element is disposed over the inner layer and in preferred embodiments there are no intermediate layers between the inner and outer layers. The outer layer generally includes one or more of the branched hydroxystyrene polymers as defined above.

The outer layer can also include other polymeric materials as film-forming binder materials in addition to the branched hydroxystyrene polymers described above. Such additional polymeric materials can include polymers formed from maleic anhydride and one or more styrenic monomers (that is styrene and styrene derivatives having various substituents on the benzene ring), polymers formed from methyl methacrylate and one or more carboxy-containing monomers, and mixtures thereof. These polymers can comprises recurring units derived from the noted monomers as well as recurring units derived from additional, but optional monomers [such as (meth)acrylates, (meth)acrylonitrile and (meth)acrylamides]. If present, such additional polymers generally comprise from about 1 to about 50 mol % of recurring units derived from maleic anhydride and the remainder of the recurring units derived from the styrenic monomers and optionally additional polymerizable monomers.

The polymer formed from methyl methacrylate and carboxy-containing monomers generally comprise from about 80 to about 98 mol % of recurring units derived from methyl methacrylate. The carboxy-containing recurring units can be derived, for example, from acrylic acid, methacrylic acid, itaconic acid, maleic acid, and similar monomers known in the art.

These other polymeric materials can be present in the outer layer in an amount of from about 25 to about 90 weight %, and preferably from about 25 to about 75 weight %, while the branched hydroxystyrene polymer is present in an amount of from about 10 to about 75 weight % and preferably from about 25 to about 75 weight %, both based on the total dry weight of the outer layer.

The outer layer may further include a monomeric or polymeric compound that includes a benzoquinone diazide and/or naphthoquinone diazide moiety. The polymeric compounds can be phenolic resins derivatized with a benzoquinone diazide and/or naphthoquinone diazide moiety as described for example in U.S. Pat. No. 5,705,308 (West et al.) and U.S. Pat. No. 5,705,322 (West et al.) that are incorporated by reference. Mixtures of such compounds can also be used. An example of a useful polymeric compound of this type is P-3000, a naphthoquinone diazide of a pyrogallol/acetone resin (available from PCAS, France). Other useful compounds containing diazide moieties are described for example in U.S. Pat. No. 6,294,311 (noted above) and U.S. Pat. No. 5,143,816 (Mizutani et al.) that are incorporated by reference. The monomeric or polymeric compound having a benzoquinone and/or naphthoquinone diazide moiety can be present in the outer layer generally in an amount of at least 5%, and preferably from about 10 to about 50%, based on total dry weight of the outer layer.

The outer layer can optionally include additional compounds that are colorants that may function as solubility-suppressing components for the alkali-soluble polymers. These colorants typically have polar functional groups that are believed to act as acceptor sites for hydrogen bonding with various groups in the polymeric binders. Colorants that are soluble in the alkaline developer are preferred. Useful polar groups include but are not limited to, diazo groups, diazonium groups, keto groups, sulfonic acid ester groups, phosphate ester groups, triarylmethane groups, onium groups (such as sulfonium, iodonium, and phosphonium groups), groups in which a nitrogen atom is incorporated into a heterocyclic ring, and groups that contain a positively charged atom (such as quaternized ammonium group). Further details and representative colorants are described for example in U.S. Pat. No. 6,294,311 (noted above). Particularly useful colorants include triarylmethane dyes such as ethyl violet, crystal violet, malachite green, brilliant green, Victoria blue B, Victoria blue R, and Victoria pure blue BO. These compounds can act as contrast dyes that distinguish the unimaged areas from the imaged areas in the developed imageable element. When a colorant is present in the outer layer, its amount can vary widely, but generally it is present in an amount of at least 0.1% and up to 30%, and preferably from about 0.5 to about 15%, based on the total dry weight of the outer layer.

The outer layer can optionally also include printout dyes, surfactants, dispersing aids, humectants, biocides, viscosity builders, drying agents, defoamers, preservatives, and antioxidants.

The outer layer generally has a dry coating coverage of from about 0.2 to about 1 g/m² and preferably from about 0.4 to about 0.7 g/m².

Although not preferred, there may be a separate layer that is in between and in contact with the inner and outer layers. This separate layer can act as a barrier to minimize migration of radiation absorbing compound(s) from the inner layer to the outer layer. This separate “barrier” layer generally comprises a polymeric material that is soluble in the alkaline developer. If this polymeric material is different from the polymeric material(s) in the inner layer, it is preferably soluble in at least one organic solvent in which the inner layer polymeric materials are insoluble. A preferred polymeric material of this type is a poly(vinyl alcohol). Generally, this barrier layer should be less than one-fifth as thick as the inner layer, and preferably less than one-tenth as thick as the inner layer.

The multi-layer imageable element can be prepared by sequentially applying an inner layer formulation over the surface of the substrate (and any other hydrophilic layers provided thereon), and then applying an outer layer formulation over the inner layer using conventional coating or lamination methods. It is important to avoid intermixing the inner and outer layer formulations.

The inner and outer layers can be applied by dispersing or dissolving the desired ingredients in a suitable coating solvent, and the resulting formulations are sequentially or simultaneously applied to the substrate using suitable equipment and procedures, such as spin coating, knife coating, gravure coating, die coating, slot coating, bar coating, wire rod coating, roller coating, or extrusion hopper coating. The formulations can also be applied by spraying onto a suitable support (such as an on-press printing cylinder).

The selection of solvents used to coat both the inner and outer layers depends upon the nature of the polymeric materials and other components in the formulations. To prevent the inner and outer layer formulations from mixing or the inner layer from dissolving when the outer layer formulation is applied, the outer layer formulation should be coated from a solvent in which, the polymeric materials of the inner layer are insoluble. Generally, the inner layer formulation is coated out of a solvent mixture of methyl ethyl ketone (MEK), 1-methoxypropan-2-ol, y-butyrolactone, and water, a mixture of diethyl ketone (DEK), water, methyl lactate, and y-butyrolactone, or a mixture of DEK, water, and methyl lactate. The outer layer formulation is generally coated out of DEK or a mixture of DEK and 1-methoxy-2-propyl acetate.

Alternatively, the inner and outer layers may be applied by conventional extrusion coating methods from melt mixtures of the respective layer compositions. Typically, such melt mixtures contain no volatile organic solvents.

Intermediate drying steps may be used between applications of the various layer formulations to remove solvent(s) before coating other formulations. Drying steps may also help in preventing the mixing of the various layers.

Representative methods for preparing multi-layer imageable elements are described below in Examples 2-5.

### Conditioning

In general, one or more imageable layers, at least one of them containing a branched hydroxystyrene polymer, are provided on a suitable substrate as noted above. A radiation absorbing compound is provided in one or more layers also, in the same or different layer as the branched hydroxystyrene polymers.

After the one or more imageable layers are dried on the substrate (that is, the coatings are self-supporting and dry to the touch), the resulting single- or multi-layer imageable element can be heat treated at from about 40 to about 90° C. (preferably at from about 50 to about 70° C.) for at least 4 hours and preferably at least 20 hours, and more preferably for at least 24 hours. This heat treatment can also be known as a “conditioning” step.

It may also be desirable that during the heat treatment, the imageable element is wrapped or encased in a water-impermeable sheet material to represent an effective barrier to moisture removal from the precursor. Preferably, this sheet material is sufficiently flexible to conform closely to the shape of the imageable element (or stack thereof) and is generally in close contact with the imageable element (or stack thereof). More preferably, the water-impermeable sheet material is sealed around the edges of the imageable element or stack thereof. Preferred water-impermeable sheet materials are polymeric films or metal foils that are sealed around the edges of imageable element or stack thereof.

Alternatively, the heat treatment (or conditioning) of the imageable element (or stack thereof) is carried out in an environment in which relative humidity is controlled to at least 25%, preferably to at least 30%, and more preferably to at least 35%. Relative humidity is defined as the amount of water vapor present in air expressed as a percentage of the amount of water required for saturation at a given temperature.

Preferably, a stack containing at least 100 of the multi-layer imageable elements are heat treated at the same time. More commonly, such a stack includes at least 500 imageable elements.

In may be difficult to achieve good wrapping at the top and bottom of such a stack using the water-impermeable sheet material and in such instances, it may be desirable to use “dummy” or reject elements in those regions of the stack. Thus, the heat-treated (or “conditioned”) stack may include at least 100 useful imageable elements in combination with dummy or reject elements. These dummy or reject elements also serve to protect the useful elements from damage caused by the wrapping or sealing process.

Alternatively, the imageable element(s) may be heat treated in the form of a coil and then cut into individual elements at a later time. Such coils can include at least 1000 m² of imageable surface and more typically at least 3000 m² of imageable surface. Adjacent coils or “spirals” or a coil, or strata of a stack may, if desired, be separated by interleaving materials, for example, papers or tissues that may be sized with plastics or resins (such as polythene).

Additional details concerning this “conditioning” process are provided in copending and commonly assigned U.S. Ser. No. 11/366,076 that was filed Mar. 2, 2006 by J. Mulligan, E. Clark, and K. Ray.

### Imaging Conditions

The single-layer and multi-layer imageable elements of this invention can have any useful form including, but not limited to, printing plate precursors, printing cylinders, printing sleeves and printing tapes (including flexible printing webs). Preferably, the imageable members are printing plate precursors for forming lithographic printing plates.

Printing plate precursors can be of any useful size and shape (for example, square or rectangular) having the requisite imageable layer disposed on a suitable substrate. Printing cylinders and sleeves are known as rotary printing members having the substrate and imageable layer in a cylindrical form. Hollow or solid metal cores can be used as substrates for printing sleeves.

During use, the single-layer and multi-layer imageable elements are exposed to a suitable source of radiation such as UV, visible light, or infrared radiation, depending upon the radiation absorbing compound present in the radiation-sensitive composition, at a wavelength of from about 150 to about 1400 nm. Preferably, imaging is carried out using an infrared laser at a wavelength of from about 700 to about 1200 nm. The laser used to expose the imaging member is preferably a diode laser, because of the reliability and low maintenance of diode laser systems, but other lasers such as gas or solid-state lasers may also be used. The combination of power, intensity and exposure time for laser imaging would be readily apparent to one skilled in the art. Presently, high performance lasers or laser diodes used in commercially available imagesetters emit infrared radiation at a wavelength of from about 800 to about 850 nm or from about 1060 to about 1120 nm.

The imaging apparatus can function solely as a platesetter or it can be incorporated directly into a lithographic printing press. In the latter case, printing may commence immediately after imaging, thereby reducing press set-up time considerably. The imaging apparatus can be configured as a flatbed recorder or as a drum recorder, with the imageable member mounted to the interior or exterior cylindrical surface of the drum. A useful imaging apparatus is available as models of Creo Trendsetter® imagesetters available from Creo, a subsidiary of Eastman Kodak Company (Burnaby, British Columbia, Canada) that contain laser diodes that emit near infrared radiation at a wavelength of about 830 nm. Other suitable imaging sources include the Crescent 42T Platesetter that operates at a wavelength of 1064 nm (available from Gerber Scientific, Chicago, Ill.) and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

IR Imaging speeds may be in the range of from about 50 to about 1500 mJ/cm², and more particularly from about 75 to about 400 mJ/cm².

While laser imaging is preferred in the practice of this invention, imaging can be provided by any other means that provides thermal energy in an imagewise fashion. For example, imaging can be accomplished using a thermoresistive head (thermal printing head) in what is known as “thermal printing”, described for example in U.S. Pat. No. 5,488,025 (Martin et al.). Thermal print heads are commercially available (for example, as Fujitsu Thermal Head FTP-040 MCS001 and TDK Thermal Head F415 HH7-1089).

Imaging is generally carried out using direct digital imaging. The image signals are stored as a bitmap data file on a computer. Such data files may be generated by a raster image processor (RIP) or other suitable means. The bitmaps are constructed to define the hue of the color as well as screen frequencies and angles.

Imaging of the imageable element produces an imaged element that comprises a latent image of imaged (exposed) and non-imaged (non-exposed) regions. Developing the imaged element with a suitable alkaline developer removes the exposed regions of the outermost layer and the layers (including the inner layer) underneath it, and exposing the hydrophilic surface of the substrate. Thus, such imageable elements are “positive-working” (for example, “positive-working” lithographic printing plate precursors). The exposed (or imaged) regions of the hydrophilic surface repel ink while the unexposed (or non-imaged) regions of the outer layer accept ink.

More particularly, development is carried out for a time sufficient to remove the imaged (exposed) regions of the outer layer and underlying layers, but not long enough to remove the non-imaged (non-exposed) regions of the outer layer. Thus, the imaged (exposed) regions of the outer layer are described as being “soluble” or “removable” in the alkaline developer because they are removed, dissolved, or dispersed within the alkaline developer more readily than the non-imaged (non-exposed) regions of the outer layer. Thus, the term “soluble” also means “dispersible”.

The imaged elements are generally developed using conventional processing conditions. Both aqueous alkaline developers and organic solvent-based alkaline developers can be used with higher pH aqueous alkaline developers preferred for the single-layer elements and higher pH organic solvent-based alkaline developers preferred for the multi-layer elements.

Aqueous alkaline developers generally have a pH of at least 7 and preferably of at least 11. The higher pH developers are generally best for processing the single-layer elements. Useful alkaline aqueous developers include 3000 Developer, 9000 Developer, GOLDSTAR Developer, GOLDSTAR Premium Developer, GREENSTAR Developer, ThermalPro Developer, PROTHERM Developer, MX1813 Developer, and MX1710 Developer (all available from Kodak Polychrome Graphics a subsidiary of Eastman Kodak Company). These compositions also generally include surfactants, chelating agents (such as salts of ethylenediaminetetraacetic acid), and alkaline components (such as inorganic metasilicates, organic metasilicates, hydroxides, and bicarbonates).

Solvent-based alkaline developers are generally single-phase solutions of one or more organic solvents that are miscible with water. Useful organic solvents the reaction products of phenol with ethylene oxide and propylene oxide [such as ethylene glycol phenyl ether (phenoxyethanol)], benzyl alcohol, esters of ethylene glycol and of propylene glycol with acids having 6 or less carbon atoms, and ethers of ethylene glycol, diethylene glycol, and of propylene glycol with alkyl groups having 6 or less carbon atoms, such as 2-ethylethanol and 2-butoxyethanol. The organic solvent(s) is generally present in an amount of from about 0.5 to about 15% based on total developer weight.

Representative solvent-based alkaline developers include ND-1 Developer, 955 Developer and 956 Developer (available from Kodak Polychrome Graphics a subsidiary of Eastman Kodak Company).

Generally, the alkaline developer is applied to the imaged element by rubbing or wiping the outer layer with an applicator containing the developer. Alternatively, the imaged element can be brushed with the developer or the developer may be applied by spraying the outer layer with sufficient force to remove the exposed regions. Still again, the imaged element can be immersed in the developer. In all instances, a developed image is produced in a lithographic printing plate having excellent resistance to press room chemicals.

Following development, the imaged element can be rinsed with water and dried in a suitable fashion. The dried element can also be treated with a conventional gumming solution (preferably gum arabic).

The imaged and developed element can also be baked in a postbake operation that can be carried out to increase run length of the resulting imaged element. Baking can be carried out, for example at from about 220° C. to about 240° C. for from about 7 to about 10 minutes, or at about 120° C. for 30 minutes.

Printing can be carried out by applying a lithographic ink and fountain solution to the printing surface of the imaged element. The ink is taken up by the non-imaged (non-exposed or non-removed) regions of the outer layer and the fountain solution is taken up by the hydrophilic surface of the substrate revealed by the imaging and development process. The ink is then transferred to a suitable receiving material (such as cloth, paper, metal, glass, or plastic) to provide a desired impression of the image thereon. If desired, an intermediate “blanket” roller can be used to transfer the ink from the imaged member to the receiving material. The imaged members can be cleaned between impressions, if desired, using conventional cleaning means and chemicals.

### EXAMPLES

The following examples are provided to illustrate the practice of the invention but are by no means intended to limit the invention in any manner.

The components and materials used in the examples and analytical methods were as follows:

ACR1478 represents a copolymer of N-phenyl maleimide/methacrylamide/methacrylic acid (58:24:18 weight %) that is prepared using conventional polymerization methods and starting materials.

ACR1755 represents a copolymer of N-[4-carboxyphenyl]methacrylamide/acrylonitrile/methacrylamide/N-phenyl maleimide (37:48:10:5 weight %) that is prepared using conventional polymerization methods and starting materials.

BC represents 2-Butoxyethanol (Butyl CELLOSOLVE®).

BLO represents y-butyrolactone.

Byk® 307 is a polyethoxylated dimethylpolysiloxane copolymer that was obtained from Byk Chemie (Wallingford, Conn.) in a 25 wt. % xylene/methoxypropyl acetate solution.

Crystal Violet is a triarylmethane dye (C.I. 42555) that was obtained from Aldrich Chemical Co. (Milwaukee, Wisc.).

Cymel® 303 is a modified melamine resin that was obtained from Cytec Industries, Inc. (West Patterson, N.J.).

DAA represents diacetone alcohol.

DEK represents diethyl ketone.

D11 represents is a triarylmethane dye (C.I. 42555), namely ethanaminium, N-[4-[[4-(diethylamino)phenyl][4-(ethylamino)-1-naphthalenyl]methylene]-2,5-cyclohexadien-1-ylidene]-N-ethyl, salt with 5-benzoyl-4-hydroxy-2-methoxybenzenesulfonic acid (1:1) that was obtained from PCAS (Longjumeau, France).

956 Developer is an organic solvent-based (phenoxyethanol) alkaline developer (Kodak Polychrome Graphics, Norwalk, Conn., a subsidiary of Eastman Kodak Company).

Ethyl violet is C.I. 42600 (CAS 2390-59-2, λₘₐₓ=596 nm) having a formula of (p-(CH₃CH₂)₂NC₆H₄)₃C⁺ Cl⁻ (Aldrich Chemical Company, Milwaukee, Wisc., USA).

IR Dye A was obtained from Eastman Kodak Company and is represented by the following formula:

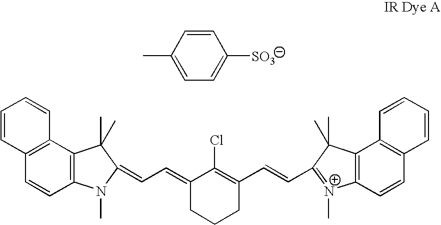

IR Dye B is Kayasorb PS210CnE, an IR dye that was obtained from Nippon Kayaku Co., Ltd. (Tokyo, Japan).

Dye C was obtained from Eastman Kodak Company (Rochester, N.Y.) and has the following structure:

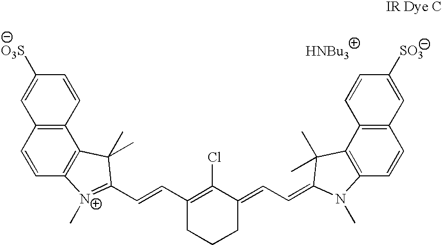

Maruka Lynkur MS-4P (or “MS-4P”) is a linear poly(4-hydroxystyrene) (Mw 7000-11,000) that was obtained from Maruzen Petrochemical Co. Ltd. (Japan).

MEK represents methyl ethyl ketone.

P3000 represents a naphthoquinone diazide of a pyrogallol/acetone resin that is available from PCAS (France).

PB 5 represents a branched poly(4-hydroxystyrene) (Mw 5500-6500) that was obtained from Hydrite Chemical Co. (Brookfield, Mass.).

PD140 represents a cresol/formaldehyde novolac resin (75:25 m-cresol/p-cresol, Mw 7000) that was obtained from Borden Chemical Co. (Louisville, Ky.).

PGME represents 1-methoxypropan-2-ol (or Dowanol PM).

PHS-B represents a highly branched poly(4-hydroxystyrene) (Mw 4500) that was obtained from Hydrite Chemical Co.

PMA represents 1-methoxy-2-propyl acetate.

RX04 represents a styrene-maleic anhydride copolymer that was obtained from Gifu Shellac (Japan).

S 0451 is an IR dye (λₘₐₓ=775 nm) that was obtained from FEW Chemicals (Germany).

S 0094 is an IR dye (λₘₐₓ=813 nm) that was also obtained from FEW Chemicals.

Substrate A represents a 0.3 mm gauge aluminum sheet that had been electrochemically grained, anodized, and treated with poly(vinyl phosphonic acid).

Sudan Black B is a neutral diazo dye (C.I. 26150) that was obtained from Aldrich Chemical Co. (Milwaukee, Wisc.).

### Invention Example 1 & Comparative Example C1

Positive-Working Single-Layer Imageable Elements

A single-layer imageable element of this invention and a Comparative element (C1) outside the invention were prepared as follows.

Imageable layer coating formulations were prepared from the components shown in the following TABLE I.

TABLE I

| | Example 1 | Comparative Example 1 |
|---|---|---|
| Component | Amount (g) | Amount (g) |
| PB-5 | 11.71 | 0 |
| Maruka Lynkur MS-4P | 0 | 11.71 |
| Crystal Violet | 0.31 | 0.31 |
| S 0094 | 0.13 | 0.13 |
| S 0451 | 0.23 | 0.23 |
| Sudan Black B | 0.13 | 0.13 |
| PGME | 87.55 | 87.55 |

The coating formulations were filtered, applied to Substrate A, and dried for 2.5 minutes at 110° C. in a Glunz&Jensen “Unigraph Quartz” oven to provide dry coating weights of about 1.5 g/m².

The resulting imageable elements were exposed on a CREO™ Lotem 400 Quantum imager at a range of energies of from 50 mJ/cm² to 110 mJ/cm² and then developed for 20 seconds at 21° C. in a Glunz&Jensen “InterPlater 85HD” processor using GOLDSTAR Premium Developer. The resulting printing plates were evaluated for sensitivity (that is, the clearing point: the lowest imaging energy at which the imaged regions are completely removed by the developer) and cyan density loss in the non-imaged areas. The viscosity (cps) of each imageable layer coating formulations was measured in a Brookfield DV-II+ viscometer (20° C., spindle N 18, 200 rpm). The results are shown in TABLE II below.

TABLE II

| | | | | Viscosity |
|---|---|---|---|---|
| | Sensitivity | Developer | Cyan Density | of 12.5% |
| Element | (mJ/cm²) | Dilution | Loss (%) | solution (cps) |
| Example 1 | 60 | Not diluted | 11.8 | 6.2 |
| C1 | >>110 | 1:6 | 52 | 10.3 |

These results show that the single-layer imageable element containing the branched hydroxystyrene polymer provided high thermal sensitivity with a clear differential in solubility between the exposed and non-exposed regions of the imageable layer. In contrast, the Comparative Element C1 was considerably less sensitive to the imaging radiation and the solubility of its imageable layer in the developer was changed insignificantly.

### Examples 2 & 3 and Comparative Examples C2 & C3

Positive-Working, Multi-Layer Imageable Elements

Multi-layer imageable elements 2 and 3 of this invention and Comparative Examples C2 and C3 were prepared as follows:

An inner layer coating formulation (per 100 g) was prepared by dissolving ACR1478 (6.34 g), IR Dye A (1.13 g), Byk® 307 (0.38 g, 10% NV in PGME) in a solvent mixture (92.17 g) of MEK/PGME/BLO/water. The resulting solution was coated onto Substrate A with a 0.012 inch (0.03 cm) wire rod and dried to provide a 1.5 g/m² dry coating weight.

Outer layer coating formulations (per 30 g) were prepared with the components shown in TABLE III below. Each coating formulation was applied to the dried inner layer using a 0.006 inch (0.015 cm) wire-wound bar and dried to provide a 0.7 g/m² coating weight.

TABLE III

| | | | | | | | | | Ethyl | | |
|---|---|---|---|---|---|---|---|---|---|---|---|
| Element | PD140 | | P3000 | | PHS-B | | RX04 | | violet | Byk ® 307 | Solvent* |
| C2 | 1.25 | g | 0.53 | g | 0 | | 0 | | 0.01 g | 0.12 g | 28.09 g |
| 2 | 0 | | 0 | | 1.78 | g | 0 | | 0.01 g | 0.12 g | 28.09 g |
| C3 | 0 | | 0 | | 0 | | 1.78 | g | 0.01 g | 0.12 g | 28.09 g |
| 3 | 0 | | 0 | | 1.34 | g | 0.44 | g | 0.01 g | 0.12 g | 28.09 g |

*DEK/PMA at a ratio of 92/8 by weight.

The imageable elements were imaged with a conventional Creo Trendsetter® 3244 platesetter. An internal pattern plot 0 was applied at a power of 8 watts, using a drum speed series to provide exposures of 92, 97, 102, 110, 115, 120, 130, 140, and 150 mJ/cm². The imaged elements were then processed in a Kodak Polychrome Graphics NE34 processor containing 956 Developer at 72° F. (about 22° C.) and a processor speed of 5 feet/minute (1.7 m/min). The processed printing plates were evaluated for clean-out energy (the minimum exposure power required to produce a clean image without scan lines) and best exposure (the exposure that produces best image quality). The results are shown below in TABLE IV. A rub-up ink was applied to Examples C2 and Invention Example 2 and the imaged areas were found to be readily ink-receptive. High quality images were produced after exposure and processing.

TABLE IV

| Element | Clean-out Energy | Best Exposure |
|---|---|---|
| C2 | 130 | >150 |
| 2 | <92 | <92 |
| C3 | 120 | 150 |
| 3 | 97 | 140 |

The results show that where PHS-B was present in the outer layer of the elements, the clean-out and best exposure energies required were much lower than when PHS-B was not present (for example, see Element C2).

An additional sample of Invention Example 2 was imaged on the Creo Trendsetter® 3244 platesetter and an internal pattern plot 0 was applied at a power of 8 watts, using drum speed series to provide exposure of 50, 60, 70, 80, 90, and 100 mJ/cm². The imageable element was processed in a Kodak Polychrome Graphics NE34 processor containing 956 Developer at 72° F. (about 22° C.) and a processor speed was 5 feet/minute (1.7 m/min). The resulting printing plate was evaluated for clean-out energy (the minimum exposure power required to produce a clean image without scan lines) and best exposure (the exposure that produces best image quality). High quality images were produced. The results are shown in the following TABLE V.

TABLE V

| Element | Clean-out Energy | Best Exposure |
|---|---|---|
| C2 | 130 | >150 |
| 2 | 60 | 70 |

The results show that where PHS-B was present in the outer layer, the clean-out energy and best exposure energy required were significantly lower than when PHS-B was not present (see Element C2).

### Examples 4 & 5 and Comparative Examples C4 & C5

Positive-Working Imageable Elements

An inner layer coating formulation (per 100 g) was prepared using the components shown in TABLE VI below and was applied to substrate A with a 0.012 inch (0.03 cm) wire-wound bar and dried to provide a dry coating weight of approximately 1.5 g/m².

TABLE VI

| | | IR | IR | | Byk ® | |
|---|---|---|---|---|---|---|
| ACR1478 | ACR1755 | Dye B | Dye C | D11 | 307 | Solvent** |
| 3.56 g | 3.16 g | 0.80 g | 0.40 g | 0.04 g | 0.40 g | 91.64 g |

**MEK/PGME/BLO/water at a ratio of 45/35/10/10 by weight

The outer layer coating formulations (per 30 g) described in TABLE VII below were applied with a 0.006 inch (0.015 cm) wire-wound bar and dried to provide a dry coating weight of approximately 0.7 g/m².

TABLE VII

| | | | | | | | | | Ethyl | | |
|---|---|---|---|---|---|---|---|---|---|---|---|
| Element | PD140 | | P3000 | | PHS-B | | RX04 | | violet | BYK307 | Solvent* |
| C4 | 1.25 | g | 0.53 | g | 0 | | 0 | | 0.01 g | 0.12 g | 28.09 g |
| 4 | 0 | | 0 | | 1.78 | g | 0 | | 0.01 g | 0.12 g | 28.09 g |
| C5 | 0 | | 0 | | 0 | | 1.78 | g | 0.01 g | 0.12 g | 28.09 g |
| 5 | 0 | | 0 | | 1.34 | g | 0.44 | g | 0.01 g | 0.12 g | 28.09 g |

*DEK/PMA at a ratio of 92/8 by weight.

The imageable elements were imaged using a conventional Creo Trendsetter® 3244 platesetter. An internal pattern plot 0 was applied at a power of 8 watts, using a drum speed series to provide exposures of 92, 97, 102, 110, 115, 120, 130, 140, and 150 mJ/cm². The imaged elements were then processed in a Kodak Polychrome Graphics NE34 processor containing 956 Developer at 72° F. (about 22° C.) and a processor speed of 5 feet/minute (1.7 m/min). The processed printing plates were evaluated for clean-out energy (the minimum exposure power required to produce a clean image without scan lines) and best exposure (the exposure that produces best image quality). The results are shown below in TABLE VIII. High quality images were produced after exposure and processing.

TABLE VIII

| Element | Clean-out Energy | Best Exposure |
|---|---|---|
| C4 | 130 | >150 |
| 4 | <92 | <92 |
| C5 | 115 | 150 |
| 5 | 110 | 130 |

The results show that where PHS-B was present in the outer layer, the clean-out and best exposure energies required were much lower than when PHS-B was not present (see Elements C4 and C5).

### Comparative Example 6:

Multi-Layer Imageable Element

An imageable element outside of this invention was prepared using “MS-4P”, a linear poly(4-hydroxystyrene (Mw 7,000-11,000) in the outer layer in place of the branched poly(4-hydroxystyrene) used in Invention Example 4 above. All other coating formulations components, imaging conditions, processing conditions, and evaluations were the same as for Invention Example 4. The results showed that use of the linear poly(4-hydroxystyrene) provided no image after exposure and processing. This result is in contrast to the use of a branched poly(4-hydroxystyrene) according to the present invention, for example in Example 4 above.

The invention has been described in detail with particular reference to certain preferred embodiments thereof, but it will be understood that variations and modifications can be effected within the spirit and scope of the invention.

1. A non-color forming, positive-working radiation-sensitive composition that upon exposure to radiation, becomes soluble or dispersible in an alkaline solution, said composition comprising a radiation-absorbing compound and a branched hydroxystyrene polymer.

2. The composition of claim 1 wherein said branched hydroxystyrene polymer comprises branched hydroxystyrene recurring units derived from 4-hydroxystyrene, which recurring units are further substituted with repeating 4-hydroxystyrene units positioned ortho to the hydroxy group, and has a weight average molecular weight of from about 1,000 to about 30,000 and a polydispersity less than 2.

3. The composition of claim 1 wherein said branched hydroxystyrene polymer is a homopolymer or a copolymer represented by the following Structure (II):
-(A)ₓ-(B)_{y}- (II)
wherein A and B together provide a polymer backbone in which A comprises branched hydroxystyrene recurring units, B represents non-branched hydroxystyrene recurring units, x represents from about 90 to 100 mol %, and y represents from 0 to about 10 mol %.

4. The composition of claim 1 wherein said branched hydroxystyrene polymer is a copolymer wherein at least 60 mol % of the recurring units are derived from hydroxystyrene wherein at least 90 mol % of said hydroxystyrene recurring units are further substituted with repeating hydroxystyrene units positioned ortho to the hydroxy groups.

5. The composition of claim 1 wherein said branched hydroxystyrene polymer is a copolymer that is represented by the following Structure (III):
-(A)ₓ-(B)_{y}-(C)_{z}- (III)
wherein A, B, and C together provide a polymer backbone in which A represents branched hydroxystyrene recurring units, B represents non-branched hydroxystyrene recurring units, and C represents recurring units different from the A and B recurring units, x represents from about 60 to 95 mol %, y represents 0 to about 10 mol %, z represents from 0 to about 40 mol %.

6. The composition of claim 5 wherein C represents recurring units derived from one or more of a (meth)acrylate, (meth)acrylamide, vinyl ether, vinyl ester, vinyl ketone, olefin, unsaturated imide, unsaturated anhydride, N-vinyl pyrrolidone, N-vinyl carbazole, 4-vinyl pyridine, (meth)acrylonitrile, and styrenic monomers other than a hydroxystyrene monomer.

7. The composition of claim 6 wherein C represents recurring units derived from one or more of a (meth)acrylate, (meth)acrylonitrile, N-substituted maleimide, and (meth)acrylamide.

8. The composition of claim 1 wherein said radiation-absorbing compound is an infrared radiation-sensitive compound.

9. A positive-working imageable element comprising a substrate having thereon an imageable layer that upon exposure to radiation, becomes soluble or dispersible in an alkaline solution and comprises a branched hydroxystyrene polymer, said element further comprising a radiation absorbing compound.

10. The element of claim 9 wherein said branched hydroxystyrene polymer comprises recurring units derived from 4-hydroxystyrene which recurring units are further substituted with repeating 4-hydroxystyrene units positioned ortho to the hydroxy group, and has a molecular weight of from about 1,000 to about 30,000 and a polydispersity less than 2.

11. The element of claim 9 wherein said radiation absorbing compound is an infrared radiation absorbing dye that absorbs radiation at a wavelength of from about 600 to about 1400 nm.

12. The element of claim 9 wherein said branched hydroxystyrene polymer is a homopolymer or a copolymer represented by the following Structure (III):
-(A)ₓ-(B)_{y}-(C)_{z}- (III)
wherein A, B, and C together provide a polymer backbone in which A represents branched hydroxystyrene recurring units, B represents non-branched hydroxystyrene recurring units, and C represents recurring units different from the A and B recurring units, x represents from about 60 to 95 mol %, y represents 0 to about 10 mol %, z represents from 0 to about 40 mol %.

13. The element of claim 12 wherein x is from about 75 to about 90 mol %, y is from 0 to about 5 mol %, and z is from 0 to about 20 mol %.

14. The element of claim 12 wherein C represents recurring units derived from one or more of a (meth)acrylate, (meth)acrylamide, vinyl ether, vinyl ester, vinyl ketone, olefin, unsaturated imide, unsaturated anhydride, N-vinyl pyrrolidone, N-vinyl carbazole, 4-vinyl pyridine(meth)acrylonitrile, and styrenic monomers other than a hydroxystyrene monomer.

15. The element of claim 12 wherein C represents recurring units derived from one or more of a (meth)acrylate, (meth)acrylonitrile, N-substituted maleimide, and (meth)acrylamide.

16. The element of claim 9 comprising a single imageable layer disposed on said substrate that comprises both said branched hydroxystyrene polymer and said radiation absorbing compound.

17. The element of claim 16 wherein said branched hydroxystyrene polymer is present at a dry coverage of from about 80 to about 99.5 weight %, and said radiation absorbing compound is an IR dye that is present at a dry coverage of from about 0.5 to about 5 weight %.

18. The element of claim 9 that comprises, on said substrate, in order:
an inner layer, and
an ink receptive outer layer that is not removable using alkaline developer before its exposure to imaging radiation, said outer layer comprising said branched hydroxystyrene polymer.

19. The element of claim 18 wherein said radiation absorbing compound is present predominantly in said inner layer.

20. The element of claim 19 wherein said branched hydroxystyrene polymer is present in said outer layer at a dry coverage of from about 20 to about 99.5 weight % and comprises from about 10 to 100 weight % of the total polymeric binders in said outer layer, and said radiation absorbing compound is an IR dye that is predominantly present in said inner layer at a dry coverage of from about 5 to about 25 weight %.

21. A method for forming an image comprising:
A) thermally imaging the imageable element of claim 9, thereby forming an imaged element with exposed and non-exposed regions in said imageable layer,
B) contacting said imaged layer with an alkaline developer to remove only said exposed regions, and
C) optionally, baking said imaged and developed element.

22. The method of claim 21 wherein imaging is carried out using radiation having a maximum absorbance of from about 700 to about 1200 nm.

23. The method of claim 21 wherein said imageable element comprises a single imageable layer disposed on said substrate that comprises both said branched hydroxystyrene polymer and said radiation absorbing compound.

24. The method of claim 21 wherein said imageable element comprises, on said substrate, in order:
an inner layer, and
an ink receptive outer layer that is not removable using alkaline developer before its exposure to imaging radiation, said outer layer comprising said branched hydroxystyrene polymer.

25. An imaged element obtained by the method of claim 21.

26. A method of providing a positive-working imageable element comprising:
A) providing an imageable layer on a substrate to provide a positive-working imageable element, said imageable layer comprising a branched hydroxystyrene polymer,
B) providing a radiation absorbing compound within said element, and
C) after drying said imageable layer, heat treating said imageable layer at from about 40 to about 90° C. for at least 4 hours under conditions that inhibit the removal of moisture from said dried imageable layer.

27. The method of claim 26 wherein said radiation absorbing compound and branched hydroxystyrene polymer are provided in different layers.
